(19) United States
(12) Patent Application Publication
(10) Pub. No.: US 2026/0189896 A1
(43) Pub. Date: Jul. 2, 2026

(54) FIXED WIRELESS ACCESS NETWORK LATENCY REDUCTION SYSTEM AND METHOD

(71) Applicant: T-MOBILE INNOVATIONS LLC, Overland Park, KS (US)

(72) Inventors: Zheng CAI, Fairfax, VA (US); Zheng FANG, McLean, VA (US)

(21) Appl. No.: 19/006,613

(22) Filed: Dec. 31, 2024

(51) Int. Cl. H04W 8/08; H04W 16/14

(52) U.S. Cl. CPC H04W 8/082; H04W 16/14

(57) ABSTRACT

Methods and systems provided herein reduce network latency for FWA deployments. The use of a WiFi protocol stack in the RAN enables local breakout to the Internet and bypassing of the core network. Further, utilization of a licensed bandwidth spectrum facilitates the use of WiFi from greater distances than traditional WiFi.

### TECHNICAL BACKGROUND

As wireless networks evolve and grow, challenges arise in communicating data across the different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G new radio (NR) and millimeter wave (mm-wave) networks, sixth generation (6G) networks, as well as 4G long-term evolution (LTE) access nodes and older legacy protocols.

Newer 6G network use cases requires high bandwidth and ultra-low latency, loss, and jitter. To this end, 6G has an expanded frequency spectrum to encompass sub-TeraHertz or TeraHertz in order to obtain more capacity. However, in these high frequency bands, the cell coverage radius is drastically reduced, for example, to around ten meters. Thus, network operators would need to deploy multiple small cells to obtain an adequate coverage radius. The deployment of the additional equipment may not be economic or practical. Further, to reduce latency in existing networks such as 5G networks, current solutions include moving the user plane function (UPF) to a network edge. However, the current edge is not the base station level and latency remains an issue. Accordingly, a solution is needed for reducing latency in evolving networks while providing necessary coverage in a practical and economical manner.

### OVERVIEW

Exemplary embodiments provided herein include a method for reducing network latency through WiFi deployment. A disclosed method for use in a wireless network includes receiving information at an access node from a wireless device, the information transmitted over a licensed bandwidth spectrum and processing the information at the access node utilizing a WiFi protocol stack located at the access node. The method further includes transmitting the processed information directly from the access node to the Internet and bypassing the core network.

Further aspects include an access node configured to reduce latency. The access node includes wireless communication components communicating with wireless devices over WiFi using a licensed spectrum bandwidth. The access node further includes a WiFi protocol stack processing communications from the wireless devices and transmitting the processed communications to a communication network directly.

In yet further aspects, a system is provided for reducing network latency. The system includes fixed wireless access (FWA) unit utilizing a WiFi protocol stack to communicate with an access node over a licensed bandwidth spectrum. The system additionally includes an access node receiving the communications from the wireless device and utilizing a WiFi protocol stack located at the access node to process the received communications and transmit the received communications to a communication network directly and bypass a core network.

### BRIEF DESCRIPTION OF THE DRAWINGS

FIG. 1 depicts an exemplary fixed wireless access (FWA) environment for implementing a system for providing low network latency in accordance with an embodiment.

FIG. 2A depicts existing end to end protocol stacks.

FIG. 2B depicts proposed protocol stacks for FWA implementation in accordance with an embodiment.

FIG. 3 depicts an exemplary system for reducing latency in an FWA environment.

FIG. 4 depicts an exemplary access node in accordance with an embodiment.

FIG. 5 depicts a further exemplary FWA unit in accordance with an embodiment.

FIG. 6 depicts an exemplary method for lowering network latency using WiFi protocol stacks in accordance with an embodiment.

FIG. 7 depicts a further exemplary method for lowering network latency by utilizing WiFi protocol stacks in accordance with an embodiment.

FIG. 8 depicts a further exemplary method for lowering network latency through utilization of WiFi protocol stacks in accordance with an embodiment.

### DETAILED DESCRIPTION

Embodiments provided herein include a method, access node, and system for reducing network latency in a fixed wireless access (FWA) environment through radio access network (RAN) modifications. FWA has been a growing aspect of wireless networks. FWA uses radio waves from base stations to send high-speed signals that offer data transfer to and from wireless devices. FWA is able to bring high-speed internet to areas where cables cannot reach and does not require fixed cables or wiring. Thus, FWA is particularly useful in areas without infrastructure as it is much less expensive and easier to implement than traditional broadband service. FWA further offers the potential for ultra-high speeds, low latency and massive capacity, allowing users to enjoy speeds comparable to a wired broadband connection.

FWA systems typically include a base station or access node connected to a fixed network and a number of subscriber units, customer premises equipment (CPEs) or FWA units spread out over a wide area. The base station or access node utilizes radio waves to communicate with the FWA units, making it possible for wireless device users to connect to the fixed network and access high-speed data services. These FWA units may be strategically attached to stationary structures such as poles, buildings or towers.

Currently implemented FWA operates at the full protocol stack of the 5G network. Certain functions of the protocol stack at both the core network and the RAN, particularly those related to mobility, are not necessary with FWA as FWA has no mobility due to the fixed nature of the FWA units. Accordingly, embodiments proposed herein utilize a protocol stack without mobility related functionality. Further, because the core network is primarily utilized for mobility related tasks, embodiments proposed herein enable bypassing of the core network through provision of local or Internet breakout at the access node. The local breakout allows offloading of Internet-bound traffic from the access node instead of routing the traffic through a data center or core network.

Embodiments proposed herein provide a system and method for reducing network latency that includes utilizing a WiFi protocol stack at the access node in order to perform a local or Internet breakout. While WiFi is typically low power with a small coverage area, it has a simple protocol stack enabling traffic to travel directly from the access node to the Internet, thus shortening network latency. In order to improve the power and coverage area, embodiments proposed herein utilize a licensed carrier bandwidth spectrum for transmitting signals over WiFi. Accordingly, because the coverage area and transmission power are regulated by spectrum rules, the use of the WiFi protocol stack over a licensed bandwidth spectrum enables existing coverage to continue to be provided without the usual limitations of WiFi.

Accordingly, in embodiments described herein, a wireless device communicates with an FWA unit running a WiFi protocol stack, which further communicates with an access node also running a WiFi protocol stack. The components communicate on a licensed spectrum. Thus, the FWA traffic utilizing WiFi can be handed over through normal procedures at the access node. Further, dynamic spectrum sharing can be implemented with WiFi and 5G NR, for example. The access node directs traffic from the wireless device directly to a communication network such as the Internet. This proposed structure results in ultra-low network latency.

An exemplary environment described herein includes at least an access node (or base station), such as a next generation NodeB (gNodeB), and at least one end-user wireless devices. For illustrative purposes and simplicity, the disclosed technology will be illustrated and discussed as being implemented in the communications between an access node (e.g., a base station) and a wireless device (e.g., an end-user wireless device).

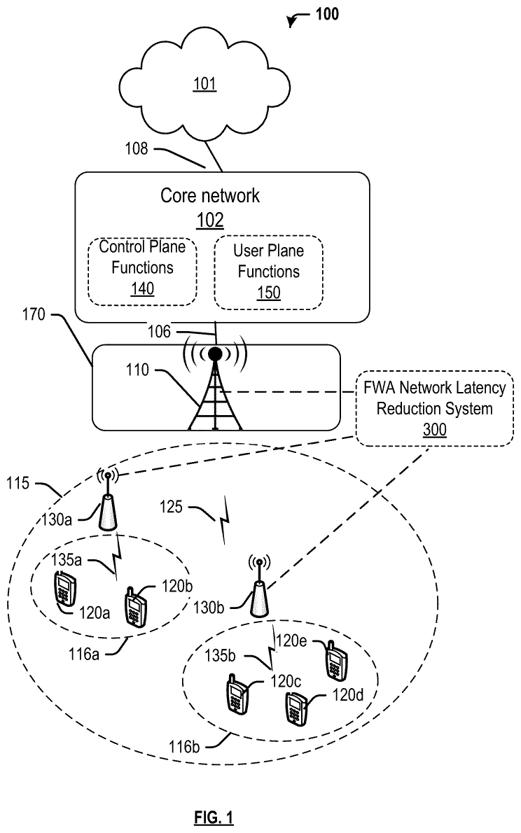

FIG. 1 depicts an exemplary environment 100 for implementing an FWA network latency reduction system 300 in a wireless network. In the displayed environment 100, the FWA network latency reduction system 300 operates to identify FWA deployments utilizing FWA units 130a, 130b to communicate with wireless devices 120a-120e and ensure use of a licensed bandwidth spectrum and a WiFi protocol stack for these deployments. The wireless devices 120a-120e may be, for example, an enhanced mobile broadband (eMBB) device, an Internet of Things (IoT) device or any other type of wireless device capable of connecting with a wireless network.

Environment 100 comprises a communication network 101, which may be the Internet, core network 102, and a radio access network (RAN) 170 including at least an access node 110 having a coverage area 115. Wireless devices 120a-120e in coverage areas 116a and 116b communicate with the FWA units 130a, 130b via wireless links 135a, 135b. Further, the FWA units 130a, 130b communicate with the access node 110 via a wireless link 125. The FWA network latency reduction system 300 operates to enable latency reduction through identification of the FWA deployment, selection and execution of a WiFi protocol stack, and use of a licensed bandwidth spectrum for transmission of information between the access node 110 and the FWA units 130a, 130b.

Additionally, components not shown may include, for example, gateway node(s) controller nodes, and additional access nodes. For example, a wireless network may include one or more access nodes, such as base stations including evolved NodeBs (eNBs) or next generation NodeBs (gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 6G or 4G long-term evolution (LTE) access nodes.

Access node 110 can be any network node configured to provide communication between end-user wireless devices 120a-120e and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like.

Further the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 120a-120e are illustrated in FIG. 1, any number of access nodes and wireless devices can be implemented within environment 100.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes.

Because the access node 110 must be capable of utilizing FWA, it requires antennas and radio transceivers that communicate with the FWA units or CPEs. The access node 110 may operate on various frequency bands, including licensed and unlicensed spectra. Common bands include, for example, 2.4 GHz, 5 GHz, and millimeter-wave bands such as 24 GHz and 60 GHz. The transmission power of the access node 110 determines its coverage area and signal strength. Higher transmission power can cover larger areas but may be subject to regulatory limits.

Further, the access node 110 may communicate with the FWA network latency reduction system 300 and may partially incorporate the FWA network latency reduction system 300. Thus, the FWA network latency reduction system 300 may perform processing in order to trigger use of a WiFi protocol stack over a licensed bandwidth spectrum to communicate with FWA units 130a, 130b. In embodiments described herein, the FWA network latency reduction system 300 is incorporated in the access node 110, but may also be distributed and include components at the access node 110 and the FWA units 130, 130b.

The FWA network latency reduction system 300 detects FWA deployments based on communication between the access node 110 and FWA units 130a, 130b. Upon identifying such deployments, the FWA network latency reduction system 300 may trigger use of a WiFi protocol stack at both the FWA units 130a, 130b and the access node 110. The use of the WiFi protocol stack enables a local breakout to the Internet from the access node 110, which will be further explained herein. Additionally, the FWA network latency reduction system 300 triggers use of a licensed bandwidth spectrum in combination with the use of the WiFi protocol stack. Use of the licensed bandwidth spectrum may be or include, for example mid-band spectrums, such as mid-band 2.5 GHz. Accordingly, permissible transmission power is determined by spectrum rules and is increased significantly from the transmission power typically allowed for WiFi deployments.

The FWA unit 130a, 130b is installed locally to the wireless device user. The FWA unit 130a, 130b communicates wirelessly with the access node 110, receiving and transmitting data to provide Internet connectivity. Directional antennas may be used to focus the signal towards the access node 110, enhancing signal strength and quality. The FWA unit 130a, 130b further includes router or modem capabilities that manage local network traffic and provide connectivity to multiple devices within the premises.

Wireless devices 120a-120e may be any device, system, combination of devices, or other such communication platform capable of communicating wirelessly with access node 110 using one or more frequency bands deployed therefrom. For example, the wireless device 120a-120e may be, for example, an eMBB device. The wireless devices 120a-120e may be or include, for example, a mobile phone, a wireless phone, a wireless modem, a personal digital assistant (PDA), a voice over internet protocol (VoIP) phone, a voice over packet (VOP) phone, a soft phone, or an Internet of Things (IoT) device well as other types of devices or systems that can exchange audio or data via access node 110 and FWA units 130a, 130b.

The core network 102 includes core network functions and elements. The core network may be structured using a service-based architecture (SBA). The network functions and elements may be separated into user plane functions 150 and control plane functions 140. In an SBA architecture, service-based interfaces may be utilized between control-plane functions, while user-plane functions connect over point-to-point link. The user plane functions (UPF) 150 access a data network, such as network 101, and perform operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120a-120e and is responsible for handling connection and mobility management tasks. The SMF is primarily responsible for creating, updating, and removing sessions and managing session context. The UDM function provides services to other core functions, such as the AMF, SMF, and NEF. The UDM function may provide a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device. Wireless network protocols can comprise multimedia broadcast multicast service (MBMS), code division multiple access (CDMA), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path, including combinations thereof. Communication links 106 and 108 can be wired or wireless and use various communication protocols such as Internet, Internet protocol (IP), local-area network (LAN), optical networking, hybrid fiber coax (HFC), telephony, T1, or some other communication format. Communication links 106 and 108 can be a direct link or might include various equipment, intermediate components, systems, and networks. Communication links 106 and 108 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as an Internet Service Provider (ISP, additional processing nodes, routers, gateways, and physical and/or wireless data links for carrying data among the various network elements, e.g. between access node 110 and Internet 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

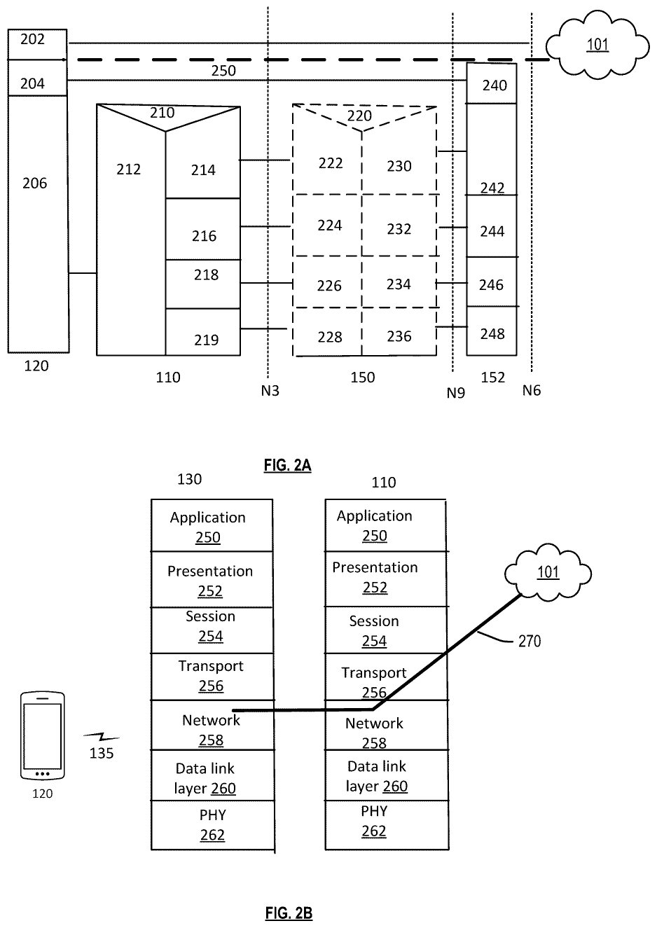

FIG. 2A illustrates a current end-to end protocol stack configuration, which may be used, for example, in a 5G network. Protocol stacks utilized for the wireless device 120, access node 110, and UPF 150 at the core network 102 are illustrated. The wireless device 120 includes an upper application layer 202, followed by a protocol data unit (PDU) layer 204, and 5G access node protocol layers 206. The access node 110 includes relay 210, 5G access node protocol layers 212, general packet radio service (GPRS) tunnelling protocol user plane (GTP-U) 214, user datagram protocol (UDP/IP) 216. The protocol stack further includes Layer 2 (L2) 218. Layer 2 may include service data adaptation protocol (SDAP), packet data convergence protocol (PDCP), radio link control (RLC), and media access control (MAC). Layer 1 (L1) 219 may be or include the physical (PHY) layer.

At the core network 102, or more specifically at the UPF 150, layers include a relay layer 220, GTP-U layer 222, 230 UDP/IP layer 224, 232, L2 226, 234, and L1, 228, 236. Further, a PDU session anchor 152 at the UPF 150 utilizes PDU layer 240, GTP-U layer 242, UDP/IP layer 244, L2, 246, and L1 248.

As illustrated, the access node 110 communicates over the N3 interface with the UPF 150, which communicates with the PDU session anchor 152 over the N9 interface. The PDU session anchor 152 interfaces with the Internet 101 over the N6 interface. Accordingly, a path 250 is traversed to enable communication of the wireless device 120 with the Internet 101. This path 250 is subjected to significant latency risk as all data traverses the core network 102 in order to reach the Internet 101.

FIG. 2B illustrates a simplified approach for the use of a WiFi protocol in an FWA environment accordance with embodiments disclosed herein. In the illustrated embodiment, the wireless device 120 communicates with the FWA unit 130 over the wireless link 135. Both the FWA unit 130 and the access node 110 utilize a WiFi protocol stack including an application layer 250, a presentation layer 252, a session layer 254, a transport layer 256, a network layer 258, a data link layer 260, and a PHY layer 262.

The application layer 250 may be or include, for example, a graphical user interface and may service as a primary user interface. The presentation layer 252 supports the functionality of the application layer 250 by providing services such as formatting and translation of data. The session layer 254 maintains a transmission path by synchronizing packets and controlling access by the application layer 250. The transport layer 256 ensures the quality of transmission and determines the best route for transmission of data using the network layer 258. The network layer 258 finds a route for transmission of data and establishes and maintains the connection between two connected nodes. In the illustrated embodiment, a local breakout route 270 is established between the network layer and the Internet 101.

The data link layer 260 creates, transmits, and receives packets and controls the PHY layer 262. Finally, the PHY layer 262 converts data into bits for transmission and converts received bits into usable data for the layers above it. WLANs use the data link layer 260 and the PHY layer 262 to format data and control the data to conform with 802.11 standards.

In operation, to facilitate transmission, the transport layer 256 sends data to the network layer 258 for routing to a receiver. The network layer 258 passes the data to the data link layer 260, which adds addressing data and control information, creating a frame. The frame is then passed to the physical layer 262. At the receiving end, the process is reversed. As data is passed down the stack from sending to receiving computers, it is encapsulated with information or data that is used by each succeeding layer. On the receiving side, the encapsulation is stripped off as the data proceeds from the physical layer 262 to the application layer 250.

As illustrated, communications in FIG. 2B are not required to reach the core network 102 due to the local breakout transmission path 270. The use of the local breakout transmission path 270 reduces latency and improves network performance.

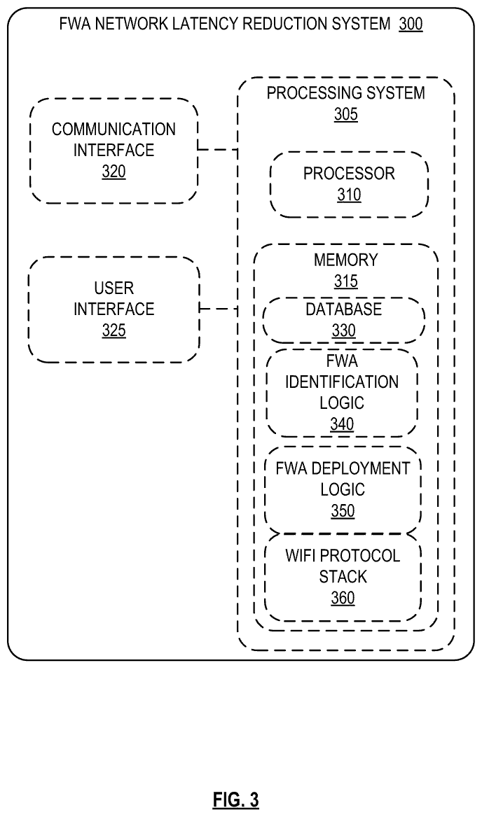

FIG. 3 illustrates an FWA network latency reduction system 300 in accordance with embodiments described herein. The components described herein are merely exemplary as many different configurations for the FWA network latency reduction system 300 may be implemented. The FWA network latency reduction system 300 may be configured to perform the methods and operations disclosed herein to trigger identification of an FWA deployment, use of a WiFi protocol stack at the RAN 170 as shown in FIG. 1, and use of a licensed bandwidth spectrum for transmission while using the WiFi protocol stack with FWA.

Thus, the FWA network latency reduction system 300 may communicate with the access node 110 and additionally or alternatively the FWA units 130a, 130b, and the wireless devices 120a-120e to recognize FWA deployments. The network latency reduction system 300 may trigger the use of WiFi protocol stacks at the FWA units 130a, 130b and at the access node 110. Further, the wireless devices 120a-120e may also use a WiFi protocol stack. In the disclosed embodiments, the FWA network latency reduction system 300 may be integrated with the access node 110, or may be an entirely separate component capable of communicating with the access node 110 and/or FWA units 130a, 130b and wireless devices 120a-120e. Further, the components of the FWA network latency reduction system 300 may be distributed so that one or more components are located within the RAN 170, and/or a separate processing node in communication with the RAN 170.

The network latency reduction system 300 may be configured for performing the operations described herein utilizing a processing system 305. Processing system 305 may include a processor 310 and a memory 315. The memory 315 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 310 to perform various methods disclosed herein. Software stored in memory 315 may include computer programs, firmware, or other form of machine-readable instructions, including an operating system, utilities, drivers, network interfaces, applications, or other type of software. For example, software stored in memory 315 may include a module for performing various operations described herein.

For example, FWA identification logic 340 may enable identification of FWA deployments within a network. Upon identification, FWA deployment logic 350 may be utilized to trigger use of a WiFi protocol stack 360 and further to trigger use of a licensed bandwidth spectrum for communication with FWA units 130a, 130b. These events may be triggered for the access node 110 and the FWA units 130a, 130b. Similarly, these events may be triggered for the wireless devices 120a-120e. Accordingly, transmission power will be regulated by bandwidth spectrum rules rather than traditional WiFi requirements. Through this process, local breakout to the Internet from the access node 110 will be facilitated such that the latency inherent in traversing the core network is eliminated.

Further, the memory 315 may include the database 330. The database 330 may store network information, and may further function as a mirroring database to assist with functions typically performed by the core network 102 since the core network 102 is bypassed during FWA implementations in accordance with embodiments proposed herein. For example, the mirroring database 330 may mirror the existing user database that is stored at the core network so that registration and authentication functions can be performed or triggered by the FWA network latency reduction system 300.

For example, the FWA network latency reductions system 300 may trigger this functionality at the access node 110. To perform the above-described operations, the stored logic may be executed by the processor 310 to manage the use of WiFi protocol stacks 360 and use of a licensed bandwidth spectrum for wireless devices 120a-120e in FWA deployment scenarios.

Processor 310 may be a microprocessor and may include hardware circuitry and/or embedded codes configured to retrieve and execute software stored in the memory 315. The FWA network latency reduction system 300 further includes a communication interface 320 and a user interface 325. Communication interface 320 may be configured to enable the processing system 305 to communicate with other components, nodes, or devices in the wireless network.

Communication interface 320 may include hardware components, such as network communication ports, devices, routers, wires, antenna, transceivers, etc. User interface 325 may be configured to allow a user to provide input to the FWA network latency reduction system 300 and receive data or information from other system components. User interface 325 may include hardware components, such as touch screens, buttons, displays, speakers, etc. The FWA network latency reduction system 300 may further include other components such as a power management unit, a control interface unit, etc.

Accordingly, the FWA network latency reduction system 300 executes instructions stored in memory 315 to determine when WiFi protocol stacks should be utilized in combination with transmission over a licensed bandwidth spectrum. Thus, the FWA network latency reduction system 300 reduces latency by bypassing the core network in FWA deployments and further is able to utilize full transmission power while using a WiFi protocol stack.

The location of the FWA network latency reduction system 300 may depend upon the network architecture. As set forth above, the FWA network latency reduction system 300 may be located in the RAN 170, in a separate processing node, or in multiple locations. Further, although shown as a single integrated system, the functions described herein may be separated and be disposed in separate locations.

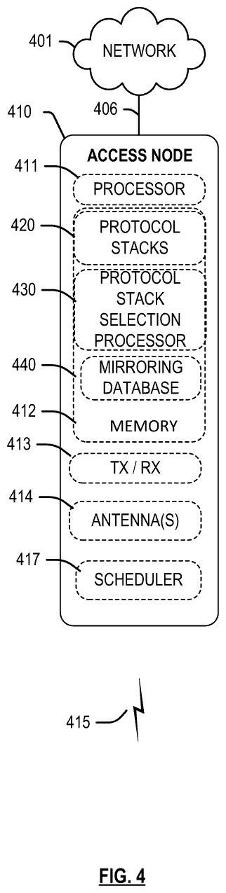

FIG. 4 depicts an exemplary access node 410. The access node 410 may be a more specific rendering of the access node 110. Access node 410 is configured as an access point for providing network services from network 401 to end-user wireless devices such as wireless devices 120a-120e. Access node 410 is illustrated as comprising a memory 412 for storing logical modules that perform operations described herein, a processor 411 for executing the logical modules, and a transceiver 413 for transmitting and receiving signals via one or more antennas 414. Combinations of antennas 414 and transceivers 413 are configured to deploy wireless air interfaces. Further, the different sets of antennas 414 can be used to implement various transmission modes or operating modes in each sector, including but not limited to multiple in multiple out (MIMO), such as 16 multiple user (MU)-MIMO and multi radio unit (RU) multi-link operation (MLO). The antennas 414 can further facilitate a quadrature amplitude modulation (QAM) scheme, such as 4096-QAM, in which a carrier waveform of fixed frequency can exist in one of 4096 possible discrete and measurable states in the constellation plot. The antennas can further facilitate transmission over a wide bandwidth spectrum, for example, up to 320 MHz. Additionally, the access node 410 is capable of carrier aggregation and different duplexing modes including frequency division duplexing (FDD) and time division duplexing (TDD).

Further, access node 410 deploys different bearers for communication with the wireless devices 120a-120e, wherein the different bearers have different characteristics. The access node 410 is communicatively coupled to network 401 via communication interface 406, which may be any wired or wireless link as described above. Scheduler 417 may be provided for scheduling resources for the wireless devices 120a-120e. Wireless communication link 415 may facilitate communication with the wireless devices 120a-120e in both uplink and downlink directions.

In an exemplary embodiment, memory 412 includes protocol stacks 420, which may include a WiFi protocol stack in addition to other protocol stacks. Further, the access node may include a protocol stack selection processor 430, which is capable of selecting and implementing a WiFi protocol stack upon identification of an FWA deployment. Further, the access node 410 may store a mirroring database 440 that mirrors information stored in databases of the core network 102. Thus, the mirroring database 440 at the access node 410 can be consulted by the access node 410 for purposes such as registration and authentication functions when the core network 102 is bypassed as described above.

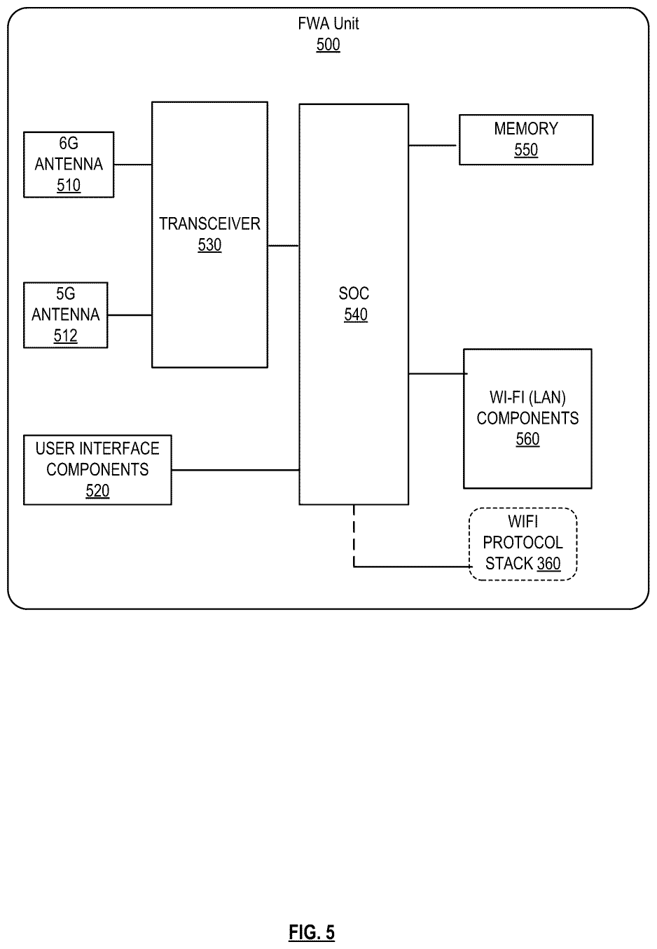

FIG. 5 illustrates an exemplary FWA unit 500 in accordance with embodiments described herein. The FWA unit 500 may be the same as or substantially similar to the FWA units 130a and 130b described above in connection with FIG. 1 The components described herein are merely exemplary as many different configurations for the FWA unit 500 may be implemented. The FWA unit 500 may include, for example, multiple antennas for communicating with a cellular network such as antenna 510 and antenna 512. Different antennas may connect with different RATs. For example, antenna 510 may connect with a 6G RAT and antenna 512 may communicate with a 5G RAT. The FWA unit 500 may further include a transceiver 530, a system on chip (SoC) 540, a memory 550, and WiFi or LAN components 560. Other components may also be included. Additionally, user interface components 520 may operate to allow set-up of the FWA unit 500. Alternatively, FWA unit 500 may be configured to interact with a wireless device 120a-120e, for example using a mobile app, for setup purposes.

The SoC 540 is an integrated circuit that integrates most or all components of a computer or other electronic system. The SoC 540 includes a central processing unit (CPU), memory interfaces, on-chip input/output devices, input/output interfaces, and secondary storage interfaces. Other components, such as a radio modem and radio frequency signal processing may also be included.

The SoC 540 integrates a microcontroller, microprocessor or perhaps several processor cores with peripherals like a GPU, WiFi and cellular network radio modems, and/or one or more coprocessors.

The components of the SoC 540 may cause the FWA unit 500 to function as a both a router and a modem in order to ensure wireless devices access to the Internet through a WLAN. The WiFi or LAN components 560 may include additional antennas, transceivers, and other components to provide the WLAN. In additional embodiments ethernet technologies are incorporated in the FWA unit 500 to add to its functionality.

Further, the FWA unit 500 is capable of implemented the WiFi protocol stack 360. The antennas 510 and 512 are capable of communicating over a licensed bandwidth spectrum.

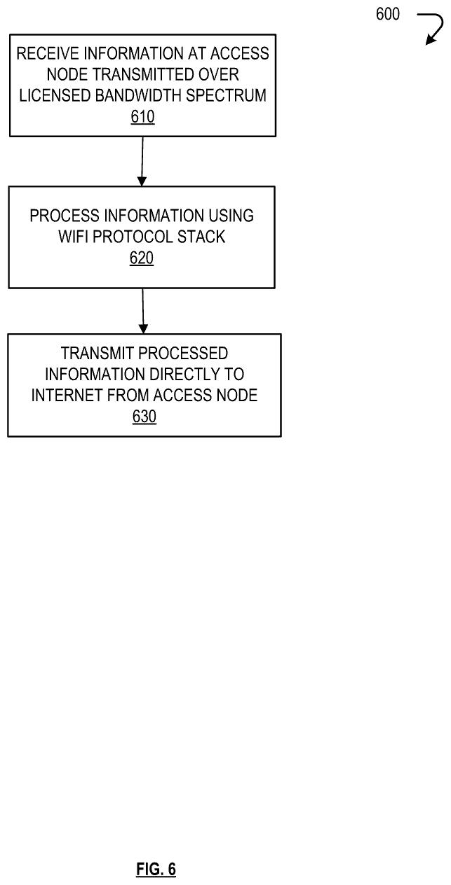

FIG. 6 illustrates an exemplary method 600 for operation of the FWA network latency reduction system 300. Method 600 may be performed by any suitable processor discussed herein, for example, the processor 310 included in the FWA network latency reduction system 300 or the processor 411 included in the access node 410. For discussion purposes, as an example, method 600 is described as being performed by the processor 411 of the access node 410.

Method 600 starts in step 610, the access node 410 receives information transmitted over a licensed bandwidth spectrum. The information may be received, for example from an FWA unit 500, which in turn may have received the information from one of the wireless devices 120a-120e.

In step 620, the processor 411 processes the received information using a WiFi protocol stack. Thus, the information is processed using the layers shown FIG. 2B including the application layer 250, the presentation layer 252, the session layer 254, the transport layer 256, the network layer 258, the data link layer 260 and the PHY layer 262.

Finally in step 630, the processor 411 performs a local Internet breakout and transmits the processed information directly to the Internet from the access node 410, thereby bypassing the core network. For example, the information is transmitted from the network layer 258 to the Internet 101.

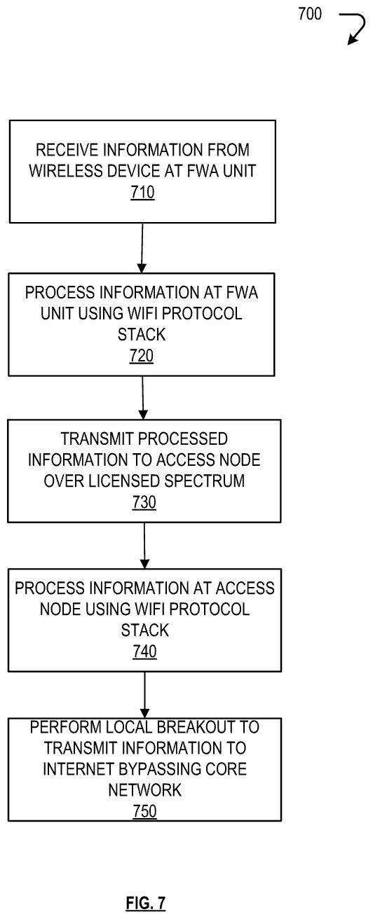

FIG. 7 illustrates a further exemplary method 700 for operation of the FWA network latency reduction system 300. Method 700 may be performed by any suitable processor discussed herein, for example, the processor 310 included in the FWA network latency reduction system 300 or the processor 411 included in the access node 410, or a processor included in the FWA unit 500 or multiple processors as discussed hereinbelow.

Method 700 starts in step 710, in which the FWA unit 500 receives information from one or more of the wireless devices 120a-120e. In step 720, the FWA unit 500 processes the information using a WiFi protocol stack, such as that described with reference to FIG. 2B. In step 730, the FWA unit 500 transmits the processed information to the access node 110 over a licensed bandwidth spectrum.

In step 740, the access node 110 processes the received information utilizing a WiFi protocol stack such as that described above with reference to FIG. 2B. Finally, in step 750, the access node 110 performs local breakout to transmit information to the Internet directly and bypass the core network.

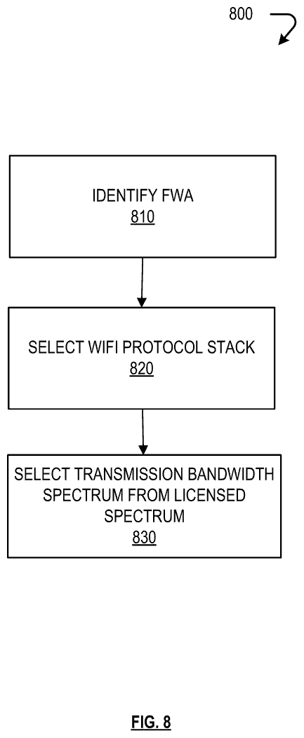

FIG. 8 illustrates an exemplary method 800 for operation of FWA network latency reduction system 300. Method 800 may be performed by any suitable processor discussed herein, for example, the processor 310 included in the FWA network latency reduction system 300 or the processor 411 included in the access node 410. For discussion purposes, as an example, method 600 is described as being performed by the processor 310 of the FWA network latency reduction system 300.

Method 800 starts in step 810, in which the processor 310 identifies an FWA deployment. Since FWA has no mobility, some of the functions like mobility can be removed from its protocol stack and it does not need the core network that handles the mobility etc. Similar in the RAN, that mobility related functions could be removed which will save RAN power consumption and reduce traffic load.

The processor 310 may notify the access node 410 of the FWA deployment. Upon notification, the access node 410 may select a WiFi protocol stack from multiple available protocol stacks at step 820. Further, in step 830, the processor 310 may trigger selection of a transmission spectrum bandwidth from available licensed spectrum bandwidth. The selection of a licensed spectrum bandwidth allows for performance of dynamic spectrum sharing with WiFi and fifth generation (5G) new radio (NR). In embodiments proposed herein, the licensed spectrum bandwidth is mid-band 2.5 GHZ or other mid-band spectrum. The selected spectrum bandwidth allow for handover of WiFi traffic using the access node 110.

In some embodiments, methods 600, 700, and 800 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 600, 700, and 800 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method for use in a wireless network including a radio access network (RAN) and a core network, the method comprising:
receiving information at an access node from a wireless device, the information transmitted over a licensed bandwidth spectrum;
processing the information at the access node utilizing a WiFi protocol stack located at the access node; and
transmitting the processed information directly from the access node to the Internet and bypassing the core network.

2. The method of claim 1, wherein transmit power between the access node and the wireless device is determined by spectrum rules.

3. The method of claim 1, further comprising utilizing a mirroring database at the access node to perform authentication and registration functions.

4. The method of claim 1, further comprising performing dynamic spectrum sharing with WiFi and fifth generation (5G) new radio (NR).

5. The method of claim 1, wherein the licensed bandwidth spectrum is a mid-band spectrum.

6. The method of claim 1, wherein the WiFi protocol stack at the wireless device and at the access node include at least an application layer, a presentation layer, a session layer, a transport layer, and a network layer.

7. The method of claim 6, wherein the WiFi protocol stack further includes a data link layer and a physical layer for wireless local area networks (WLANs).

8. The method of claim 6, wherein the access node is a sixth generation (6G) access node.

9. The method of claim 1, wherein the wireless device communicates with the access node through a fixed wireless access (FWA) unit.

10. An access node comprising:
wireless communication components communicating with wireless devices over WiFi using a licensed bandwidth spectrum; and
a WiFi protocol stack processing communications from the wireless devices and transmitting the processed communications to a communication network directly.

11. The access node of claim 10, wherein transmit power between the access node and the wireless devices is determined by spectrum rules.

12. The access node of claim 10, further comprising a mirroring database to perform authentication and registration functions.

13. The access node of claim 10, wherein the access node facilitates dynamic spectrum sharing with WiFi and fifth generation (5G) new radio (NR).

14. The access node of claim 10, wherein the licensed bandwidth spectrum is a mid-band spectrum.

15. The access node of claim 10, wherein the access node is a sixth generation (6G) access node.

16. A system comprising;
an access node receiving communications from a wireless device and utilizing a WiFi protocol stack located at the access node to process the received communications and transmit the received communications to a communication network directly and bypass a core network; and
a fixed wireless access (FWA) unit utilizing a WiFi protocol stack to communicate with the access node over a licensed bandwidth spectrum.

17. The system of claim 16, wherein the system supports multiple user (MU) multiple in multiple out (MIMO) and multi-link operation (MLO).

18. The system of claim 16, wherein the access node is capable of providing dynamic spectrum sharing with WiFi and fifth generation (5G) new radio (NR).

19. The system of claim 16, wherein the licensed bandwidth spectrum is a mid-band spectrum.

20. The system of claim 16, wherein the access node is a sixth generation (6G) access node.
